(19) United States
(12) Patent Application Publication
(10) Pub. No.: US 2009/0254547 A1
(43) Pub. Date: Oct. 8, 2009

(54) RETRIEVING APPARATUS, RETRIEVING METHOD, AND COMPUTER-READABLE RECORDING MEDIUM STORING RETRIEVING PROGRAM

(75) Inventor: Ichiro HIROTA, Tokushima-shi (JP)

Correspondence Address: SUGHRUE MION, PLLC, 2100 PENNSYLVANIA AVENUE, N.W., SUITE 800, WASHINGTON, DC, 20037, US

(73) Assignee: JUSTSYSTEMS CORPORATION, Tokushima-shi (JP)

(21) Appl. No.: 12/418,881

(22) Filed: Apr. 6, 2009

(30) Foreign Application Priority Data
Apr. 7, 2008 (JP) 2008-099101

(51) Int. Cl. G06F 17/30

(52) U.S. Cl. 707/5; 707/3; 707/E17.017; 707/E17.014

(57) ABSTRACT

A retrieving server 130 includes an input unit 351 that receives a plurality of search conditions of different categories; plural search units 340 (341 to 344) that are provided respectively for each of the categories and execute searches based on the search conditions; a processing unit 352 that, based on the search conditions received by the input unit 351, causes a search unit provided for a corresponding category to execute a search and outputs search results obtained; and a display control unit 353 that causes the search results output from the processing unit 352 to be displayed by a display screen having a layout corresponding to the category. The processing unit 352, through an operation of the display screen depicting the search results, further receives search conditions of another category and narrows down the search conditions.

### CROSS-REFERENCE TO RELATED APPLICATIONS

This application is based upon and claims the benefit of priority of the prior Japanese Patent Application No. 2008-099101, filed on Apr. 7, 2008, the entire contents of which are incorporated herein by reference.

### BACKGROUND OF THE INVENTION

1. Field of the Invention

The present invention relates to a retrieving apparatus, a retrieving method, and a retrieval program that present results of retrieval by various conditions and in particular, relates to a retrieving apparatus, a retrieving method, and a retrieval program that present results of retrieval by desired conditions in an easy-to-understand, intuitive screen.

2. Description of the Related Art

Conventionally, retrieval services receive input of a search keyword and, retrieve and present web pages that include the search keyword. The web pages may be presented classified into hierarchical categories. New retrieval services have appeared such as meta search engines that execute cross-searches using plural search engines (for example, refer to Japanese Patent Application Laid-Open Publication No. 2002-351916).

Conventional technologies, however, fail to provide a screen capable of appropriately presenting the retrieved results to a user. For example, when the results are displayed in a hierarchical form, manual operation is required to switch the hierarchy by which the results are displayed. If search conditions are changed during the course of a search, the search cannot be executed to reflect cumulatively the results obtained. At the same time, with respect to the display screen presenting the retrieved results, a mere display of the results according to search condition requires switching between search result displays and cannot provide a desirable and appropriate presentation to the user. Thus, a problem arises in that despite the high performance of a search engine, desired information may not be found among enormous amount of information retrieved.

### SUMMARY OF THE INVENTION

It is an object of the present invention to at least solve the above problems in the conventional technologies.

A retrieving apparatus according to one aspect of the invention includes an input unit that receives plural search conditions of different categories; plural search units that are provided respectively for each of the categories and execute searches based on the search conditions; a processing unit that, based on the search conditions received by the input unit, causes a search unit provided for a corresponding category to execute a search and outputs search results obtained; and a display control unit that causes the search results output from the processing unit to be displayed by a display screen having a layout corresponding to the category. The processing unit, through an operation of the display screen depicting the search results, further receives search conditions of another category and narrows down the search conditions.

A retrieving method according to another aspect of the invention includes receiving plural search conditions of different categories; searching with respect to each of the categories and based on the search conditions; processing to, based on the search conditions received at the receiving, cause searching with respect to a corresponding category and output search results obtained; and controlling to cause the search results output at the processing to be displayed by a display screen having a layout corresponding to the category. The processing includes processing, through an operation of the display screen depicting the search results, to further receive search conditions of another category and narrow down the search conditions.

A computer-readable recording medium according to still another aspect of the present invention stores therein a retrieval program that causes a computer to execute the retrieving method according to claim 15.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a diagram of an overall configuration of a retrieving system to which a retrieving apparatus of the present invention is applied;

FIG. 2 is a block diagram of the retrieving apparatus according to an embodiment of the present invention;

FIG. 3 is a block diagram of a functional configuration of the retrieving apparatus according to the embodiment;

FIG. 4 is a diagram of an example of internal data of an index information database;

FIG. 5 is a diagram of search conditions displayed at the time of a search;

FIG. 6 is a diagram of search results displayed by a location axis;

FIG. 7 is a diagram of one example of a clustering of search results;

FIG. 8 is diagram of another example of clustering;

FIG. 9 is diagram of another example of clustering;

FIG. 10 is a diagram of an intermediate image when the axis of the search is switched;

FIG. 11 is a diagram of a main screen in a defocused state;

FIG. 12 is a diagram of focus switching of display characters in a search result display window;

FIG. 13 is a diagram of a state in which narrowing-down conditions are added;

FIG. 14 is a diagram of a state in which narrowing-down conditions are added;

FIG. 15 is a diagram of an example of period display by a date of the search results by the time axis;

FIG. 16 is a diagram of an example of period display by a month of the retrieval results by the time axis; and

FIG. 17 is a diagram of an example of period display by an hour of the search results by the time axis.

### DETAILED DESCRIPTION OF THE PREFERRED EMBODIMENTS

Referring to the accompanying drawings, exemplary embodiments according to the present invention are explained in detail below.

According to exemplary embodiments, information display is proposed that can narrow down information by taking various search conditions (keys) as axes and combining plural axes to intuitively and simply present search results to a user.

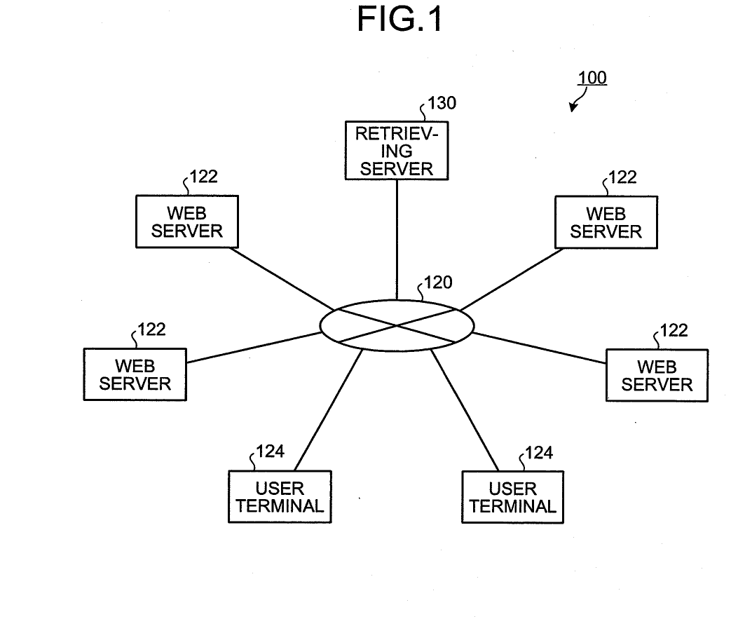

FIG. 1 is a diagram of an overall configuration of a retrieving system to which a retrieving apparatus of the present invention is applied. A retrieving server 130, a web server 122, and a user terminal that make up a retrieving system 100 are connected to, for example, a network 120 such as Internet. Although described herein to be applicable as the retrieving server 130 connected to the network 120, the retrieving apparatus of the present invention may be applied further as the user terminal 124 having a function of receiving and displaying search results input by the retrieving server 130.

The retrieving server 130 acquires from the web server 122, the contents of web pages made available by the web server 122; analyses the contents; generates index information; and registers the information in a database. The user terminal 124 accesses the retrieving server 130 and makes a query indicating search conditions. The retrieving server 130 searches the database, retrieves content matching the search conditions indicated by the user, and presents to the user terminal 124, a list of URLs of the content matching the search conditions. By clicking a link to the desired content among the list, the user may browse the desired content.

The retrieving server 130 provides a retrieval service capable of searching based on different categories (referred to as axes) such as “word (phrase) search”, “map” “time”, and “person” as keys. The retrieving server 130 has a function of clustering the results retrieved. Search engines respectively provide an intuitive and easy-to-operate search UI according to characteristics of the information used as the key. For example, a search engine that executes searches with “time” as a key provides a UI such as a calendar and a time slider for receiving designation of time. A search engine that executes searches with a “map” as a key provides a UI of a map, etc.

The retrieving server 130 provides an integrated UI that combines these search engines and narrows down the information, thereby enabling complex information acquisition such as obtaining the results of a search by “map” further narrowed down by “time”. Further, it becomes possible to make a comparative study from various aspects while maintaining the results of various search engines, to efficiently support the user in his knowledge discovery, and to greatly enhance usability.

### (Hardware Configuration of Retrieving Apparatus)

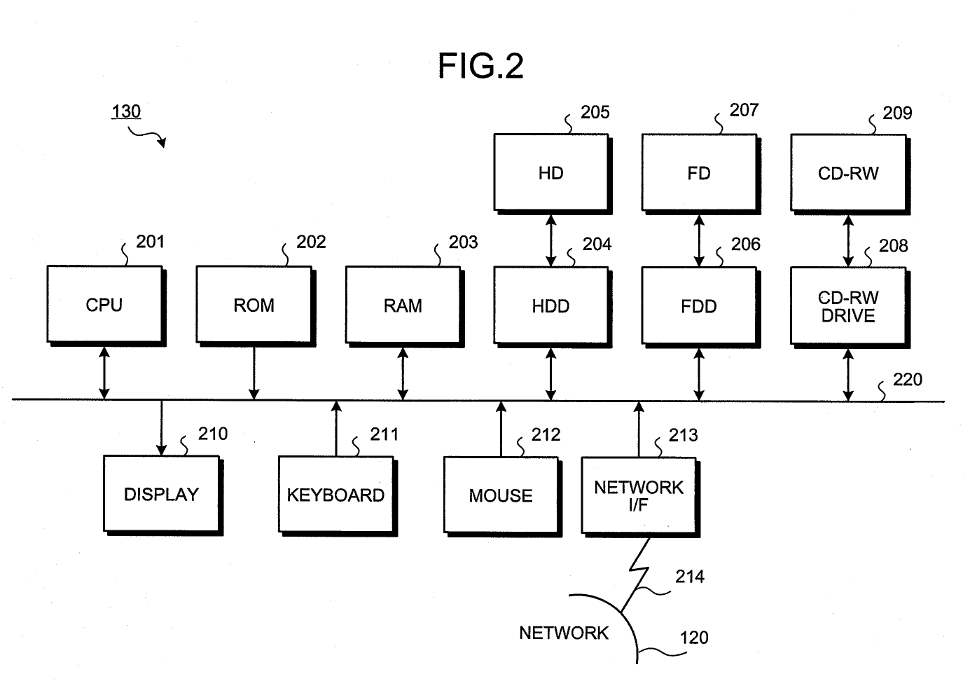

A hardware configuration of the retrieving apparatus according to an embodiment of the present invention will be described. FIG. 2 is a block diagram of the retrieving apparatus according to the embodiment of the present invention. As depicted in FIG. 2, a retrieving server 130 includes a CPU 201, a ROM 202, a RAM 203, an HDD (hard disk drive) 204, an HD (hard disk) 205, an FDD (flexible disk drive) 206, an FD (flexible disk) 207, a CD-RWD (CD-RW drive) 208, a CD-RW 209, a display 210, a keyboard 211, a mouse 212, and a network I/F 213, connected to one another by way of a bus 220. The network I/F (interface) 213 is equipped with a communication cable 214 for connecting to a network (NET) 120.

The CPU 201 governs overall control of the retrieving apparatus 130. The ROM 202 stores therein programs such as a retrieval program. The retrieval program stored in the ROM 202 is read and executed under the control of the CPU 201. The RAM 203 is used as a work area of the CPU 201.

The HDD 204, under the control of the CPU 201, controls the reading and writing of data with respect to the HD 205. The HD 205 stores therein the data written under control of the HDD 204. The data stored in the HD 205 is read out under the control of the HDD 204.

The FDD 206, under the control of the CPU 201, controls the reading and writing of data with respect to the FD 207. The FD 207 stores therein the data written under control of the FDD 206, the data being read out under the control of the FDD 206.

The CD-RWD 208, under the control of the CPU 201, controls the reading and writing of data with respect to the CD-RW 209. The CD-RW 209 is a removable recording medium storing data written under the control of the CD-RWD 208. Data stored on the CD-RW 209 is read out under the control of the CD-RWD 208.

The display 210, under the control of the CPU 201, displays a cursor, menus, windows, or various types of data such as documents, images, etc. The keyboard 211 is an input device equipped with keys for the input of characters, numerals, and various instructions, and data is entered through the keyboard 211. The mouse 212 performs cursor movement, range selection, and movement, size change, etc., of a window. The mouse 212 uses a touch panel for receiving input of stroke by a finger or a pen at the time of hand-written input. The mouse 212 may use a tablet composed of the display 210 and a transparent touch panel provided over the display 210.

The network I/F 213 connects with the network 120 such as a LAN and a WAN by way of the communication cable 214 and functions as an interface between the network 120 and the CPU 201.

The retrieving server 130 according to the present embodiment is equipped with the above hardware and executes retrieval by executing the retrieval program stored on the ROM 202, under the control of the CPU 201. A function of the retrieval program is to present retrieved results to the user on an easy-to-understand display screen.

### (Functional Configuration of Retrieving Apparatus)

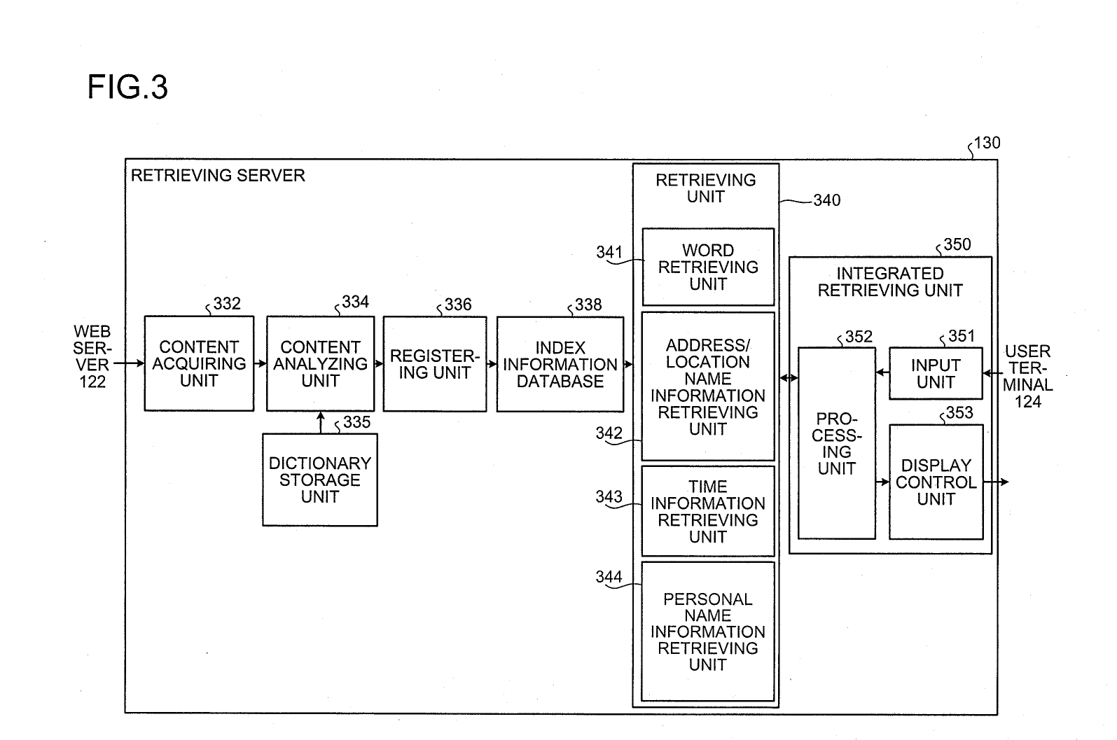

Functional configuration will be described of the retrieving server 130. FIG. 3 is a block diagram of a functional configuration of the retrieving apparatus according to the embodiment. FIG. 3 depicts mainly a display function of displaying search results by plural axes as a main configuration of the present invention.

As depicted in FIG. 3, the retrieving server 130 includes a content acquiring unit 332, a content analyzing unit 334, a registering unit 336, an index information database 338, a retrieving unit 340, and an integrated retrieving unit 350. While such a configuration may be realized, in terms of hardware components, by a CPU, a memory, a program loaded to the memory, etc., of an arbitrary computer, FIG. 3 depicts functional blocks that are realized by cooperation of the hardware components. Therefore, the functional blocks may be realized by hardware alone, software alone, or a combination thereof.

The content acquiring unit 332 accesses the web server 122 by way of the network 120 and acquires the contents of a web page stored by the web server 122. When the retrieving server 130 retrieves the contents stored in a hard disk, etc. thereof in a stand-alone environment, the content acquiring unit 332 accesses a storage device connected to the apparatus and acquires the contents stored therein. The content analyzing unit 334 analyzes the contents acquired by the content acquiring unit 332 and extracts information serving as keys for a search. The registering unit 336 registers index information of the contents extracted by the content analyzing unit 334 to the index information database 338.

The content analyzing unit 334, using a named entity extraction technique, extracts named entities included in the web page, for example, information concerning date, location name, designation of an object, telephone number, personal name, organization name, etc.; indexes the named entities; and registers the named entities in the index information database 338. The content analyzing unit 334 may use a morphological analysis technique to disassemble the text information in the contents into morphemes and extract the named entities from nouns among the morphemes, by referring to a dictionary, etc. stored in a dictionary storage unit 335. At this time, a thesaurus including synonyms, antonyms, etc., or an ontology dictionary, etc. having information representing conceptual classifications may be referenced.

The content analyzing unit 334, when extracting time information from the contents, may acquire information indicative of preparation date/time or update date/time of the contents and supplement the time information. For example, when only the date is stated and the year is missing, preparation year of the contents may be supplemented. The content analyzing unit 334 may specify the extent of the validity of the information concerning a time, an address, etc., by analyzing the structure, etc. of the contents. For example, when, a website of a company includes a web page that outlines the company or the like, location information on the web page is considered to represent the address of the company and therefore, configuration may be such that the web contents under such domain will be regarded collectively and the location of the company will be correlated as the address information thereof.

In a web page including a list of restaurants, correspondence between the name and the address of the restaurants may be analyzed based on the layout of a table, etc. When the web page of a private individual includes a web page of a collection of links, the content analyzing unit 334 may extract and correlate relationships between personal names. The contents are systematized from various aspects by such techniques.

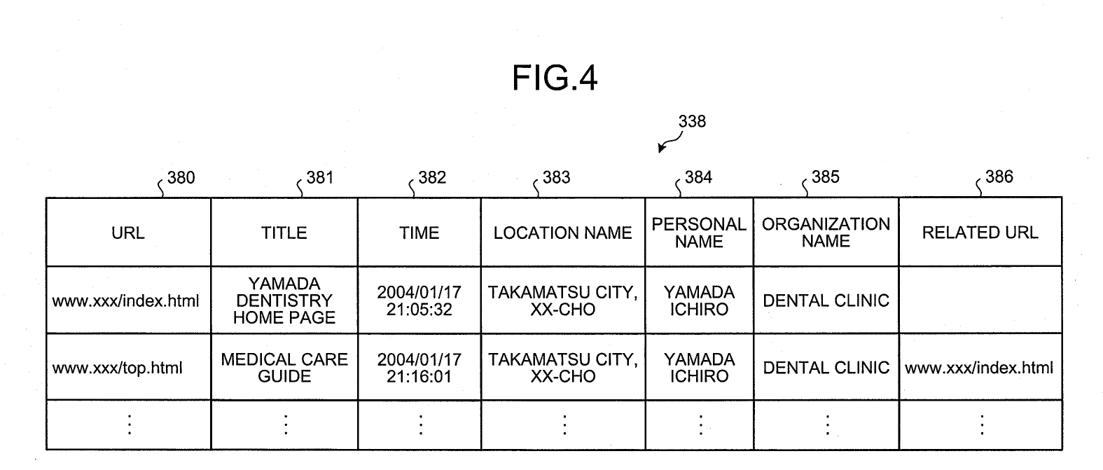

FIG. 4 is a diagram of an example of internal data of the index information database. The index information database 338 has a URL column 380, a title column 381, a time column 382, a location name column 383, a personal name column 384, an organization name column 385, and a related URL column 386. The URL column 380 stores the URL of the contents of a web page, etc. The title column 381 stores the title of the contents. The time column 382, the location name column 383, the personal name column 384, and the organization name column 385 respectively store time information, location name information, personal name information, and organization name information included in the contents extracted by the content analyzing unit 334.

As described, by indexing the extracted information, a search may be realized that uses various types of information as keys. The related URL column 386 stores the URL of related content. Related content may be, for example, content that is referenced such as content to which the particular contents are linked or content that sets the particular contents as a destination of link or may be content highly similar to the particular contents. Content relationships may be built according to folder hierarchy, etc. in the web server 122 or as described above, according to relationships between persons. The index information database 338 may further store keywords included in the contents, preparation date/time and update date/time of the contents and may further store such information as a time range (start time, finish time, and start time to finish time).

The description of FIG. 3 continues. The retrieving unit 340 receives search conditions, refers to the index information database 338, and retrieves content that satisfies the conditions. The retrieving unit 340 includes plural search engines that execute searches using different types of information as keys to retrieve content.

A word retrieving unit 341 searches each column (URL column 380 to related URL column 386) of the index information database 338, using an arbitrary word (phrase) as a key. The word retrieving unit 341 has a function of clustering the retrieved results and, for example, presents the retrieved results, separating phrases of the same classification from phrases of other classifications.

An address/location name information retrieving unit 342 searches the index information database 338, using information such as an address, a location name, and longitude/latitude as a key. The address/location name information retrieving unit 342 provides a map-based screen as the UI, and on a map, maps the content that include the location name or location information, thereby enabling the user to reach the information from map browsing. The address/location name information retrieving unit 342 has a function of clustering content related to the address/location name and, for example, presents the content classified by area.

A time information retrieving unit 343 searches the index information database 338, using time information as a key. The time information retrieving unit 343 displays a screen based on a time axis such as a calendar and a time slider as the UI and maps on the calendar, the time slider, etc., content that includes the time information, so that clicking on any of such mapped content may cause the display on the screen to jump to a corresponding page. The time information retrieving unit 343 further presents the time-related content clustered, for example, by date.

A personal name information retrieving unit 344 searches the index information database 338, using personal name information as a key. The personal name information retrieving unit 344 presents content related to a personal name clustered, for example, by name, where individuals having the same family name and the same first name are classified together. If a person is designated, the personal name information retrieving unit 344 retrieves information so that detailed information on the person, for example, his personal history and latest information, may be known extensively. The personal name information retrieving unit 344 may further present personal relationships.

As described, since each search engine provides an intuitive, easy-to-operate UI, usability may be enhanced.

The integrated retrieving unit 350 includes an input unit 351 that receives the search conditions for each of the search engines from the user terminal 124 and a display control unit 353 that provides the user terminal 124 with a user interface (display screen) that integrates plural user interfaces for a presentation of the retrieved results. A processing unit 352 notifies the search engines of their respective search conditions received from the input unit 351 and causes the engines to execute searches.

Upon acquiring search results from the search engines, the integrated retrieving unit 350 presents the search results, which satisfy the search conditions received from the user; thereby making it possible to easily perform narrowing-down searches using plural keys taken as axes.

An example will be described of the extraction of content with respect to the database depicted in FIG. 4. For example, if the user has a map of Takamatsu and the vicinity displayed by the location axis and executes a search after selecting a dental clinic from a field classification tree and inputting “implant” as a keyword, the retrieving unit 340 extracts from the index information database 338, content having information of “Takamatsu and the vicinity” as location name information, information of “dental clinic” or the like as field information, and “implant” as a keyword. Here, the address/location name information retrieving unit 342, in searching for content that includes the location name information of “Takamatsu and the vicinity”, may not only search for content that includes “Takamatsu” as the location name information but also extract the names of places in the vicinity of “Takamatsu” by referring to, for example, a dictionary of location names, etc., and further search for content that includes the extracted location names. The display control unit 353 refers to the location name information of the extracted content and displays an icon at corresponding positions on a map. When the user clicks an icon, the screen jumps to the content corresponding thereto.

### (About User Interface at Time of Retrieval)

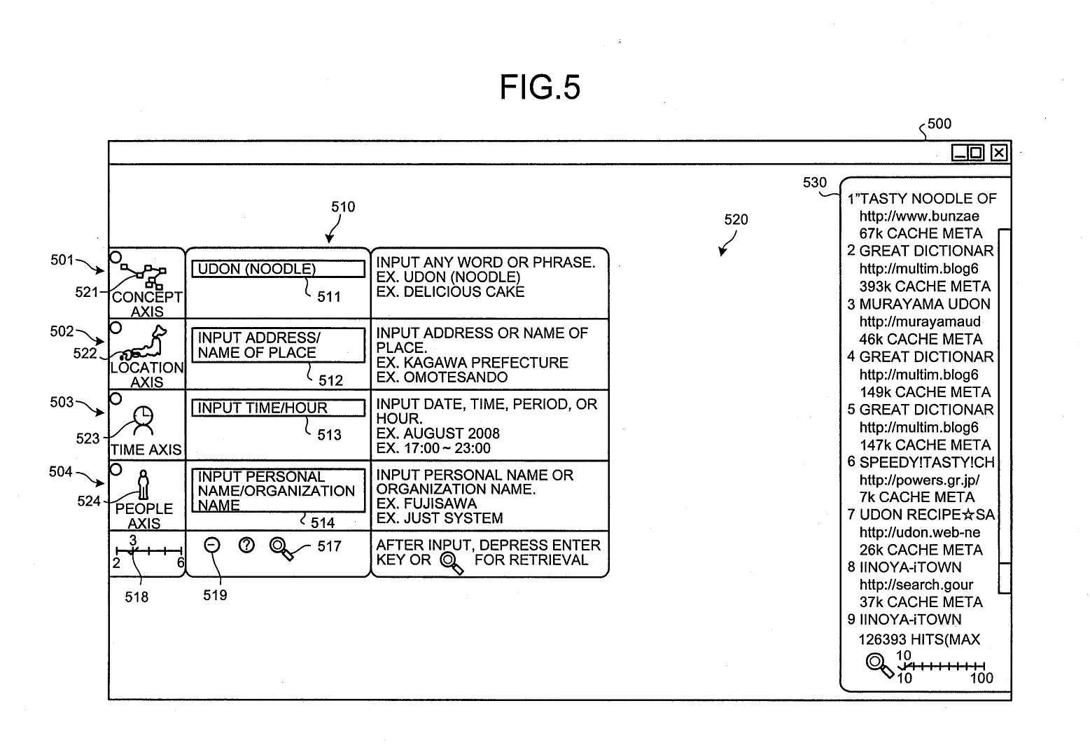

FIG. 5 is a diagram of search conditions displayed at the time of a search. As depicted, a display screen displays an axis window 510 at a left side, a main screen 520 centrally, and a search result display window 530 at a right side.

The axis window 510 displays, in vertical direction, a phrase (word) search condition setting unit 501, a map search condition setting unit 502, a time search condition setting unit 503, and a people (organization name) search condition setting unit 504. The phrase search condition setting unit 501 is provided with an item input unit 511 for inputting an arbitrary phrase and an icon 521 for selecting the phrase search. The map search condition setting unit 502 is provided with an item input unit 512 for inputting an address or a location name and an icon 522 for selecting the map search. The time search condition setting unit 503 is provided with an item input unit 513 for inputting a date, a period, or a time and an icon 523 for selecting the time search. The people search condition setting unit 504 is provided with an item input unit 514 for inputting a personal name or an organization name and an icon 524 for selecting the people search.

Through an input of search phrases to the item input units 511 to 514 and manipulation of a search button 517, a search is executed based on the input phrases. At the time of this search, the processing unit 352 causes the word retrieving unit 341, the address/location name information retrieving unit 342, the time information retrieving unit 343, and the personal name information retrieving unit 344 corresponding to the respective search condition setting units 501 to 504 to execute a search using the input phrases as keys. A search phrase may be input to one or more of the item input units 511 to 514 and further, a search may be executed by a combination of the phrases. Further, an input of plural phrases to each of the item input units 511 to 514 and a search by a combination of the phrases may be executed.

In the vicinity of the search button 517, a setting slider 517 is provided for setting the number of divisions at the time of clustering to be described later. The setting slider 517 is set at 3-divisions in the illustrated example and 2- to 6-divisions are possible by moving the setting slider 518.

The example depicted in FIG. 5 assumes that, to search for “udon (noodle)”, the word “udon” is input to the item input unit 511 of the phrase search condition setting unit 501 and the search button 517 is manipulated. Consequently, the processing unit 352 receives the search results and the display control unit 353 displays the search results. At this time, the search result display window 530 on the right side of the display screen 500 displays the search results for “udon”. The search result display window 530 displays a website list for the top websites (the top 9 websites in the example depicted) that include the most web pages hit by “udon”. Reference numeral 519 represents a clear button that clears all search conditions.

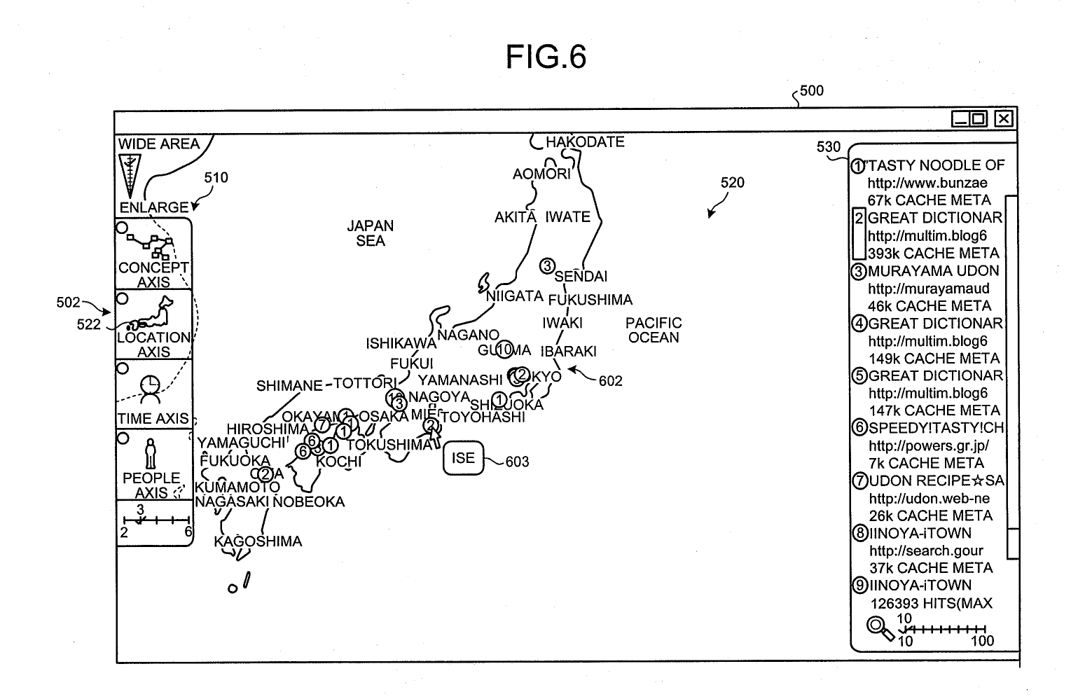

FIG. 6 is a diagram of the search results displayed by the location axis. After the search depicted in FIG. 5, if the icon 522 is manipulated to select the map search condition setting unit 502, then the “udon” is searched for by the address/location name information retrieving unit 342. The display control unit 353 causes the search results to be displayed on the main screen 520 by the location axis. At this time, map information 602 corresponding to the search results is displayed at the center of the screen. The processing unit 352 displays a map corresponding to the location names included in the search results. As depicted in FIG. 6, the search results for “udon” indicate mainly hits of web pages having addresses or the names of places in the western part of Japan. For this reason, the display control unit 353 shifts the display of the map to center on the western part of Japan.

Encircled numerals, 1, 2, . . . , displayed on the map information 602 correspond to the encircled numerals of the websites displayed in the search result display window 530. For example, an encircled numeral 2 indicates an address or the name of a place included in the website of the “Great Dictionary of Everything” displayed as the second item in the search result display window 530 and the display control unit 353 displays the location on the map information 602 corresponding to such address or location name, marked by the encircled numeral 2. Configuration is such that when the cursor is moved to the encircled numeral 2, the corresponding location name “Ise” is displayed by a pop-up indicator 603, thereby making it possible to identify in more detail the place of the encircled numeral 2 displayed on the map information 602 and aid in the display of the search results.

According to such map information 602, the address or location name information included in the search results for “udon” may be arranged at the corresponding location on the map information 602 and the search results may be displayed at appropriate locations on the map. The pop-up indicator 603, besides displaying the location name in the case of the map information 602, may display a date or time on a time-axis display to be described later.

### (Clustering)

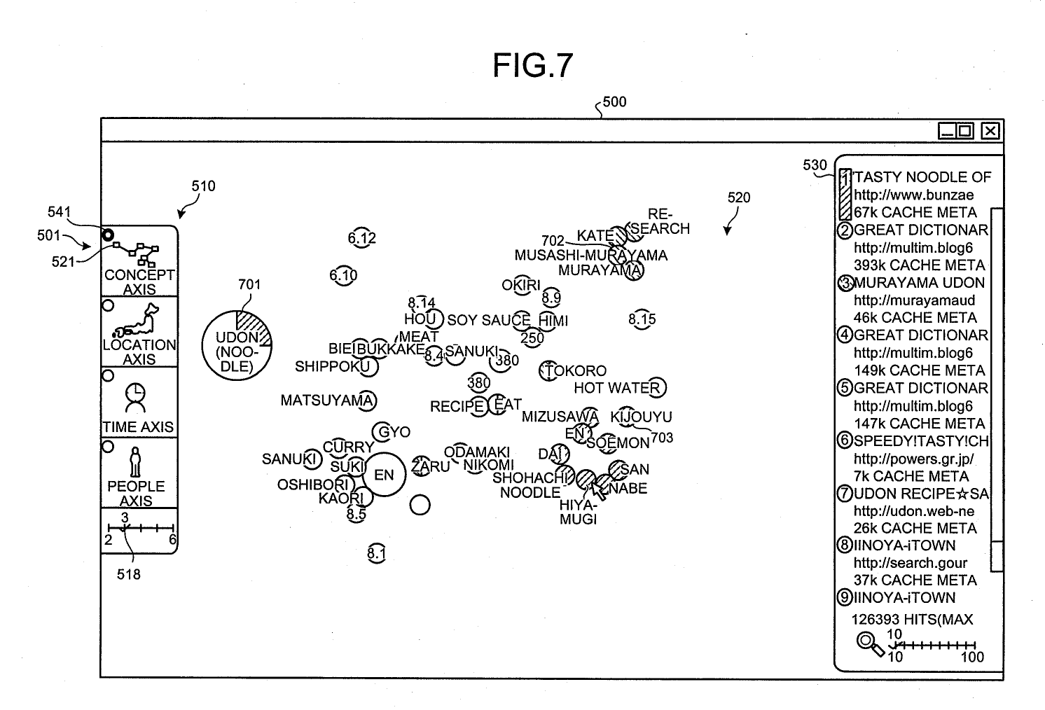

FIG. 7 is a diagram of one example of clustering of search results. The search results may be clustered by each axis. For example, through a manipulation of a clustering selecting button 541 provided in the word search condition setting unit 501, the phrases included in text of the websites obtained as the above search results may be classified into a predetermined number of groups based on the clustering (technique of vector retrieval, etc., according to similarity). In the example depicted in FIG. 7, the division number n of the clustering is set at 3-divisions via the setting slider 518.

Specifically, a page group is divided into three parts by the frequency vector of [word|map|time|people] and a circle graph is displayed by the following processing: (1) divide the page group of the search results into three clusters; (2) each cluster is colored by a respective color; (3) when a certain phrase is focused on, the phrase is included in one or more pages, thus the phrase belongs to one or more clusters; (4) display a circle graph indicating in which cluster and at what frequency the phrase is included. Consequently, in the example depicted, the display control unit 353 displays on the display screen 500, a circle graph for “udon” indicating ¼ included in cluster 1 and ¾ in cluster 2.

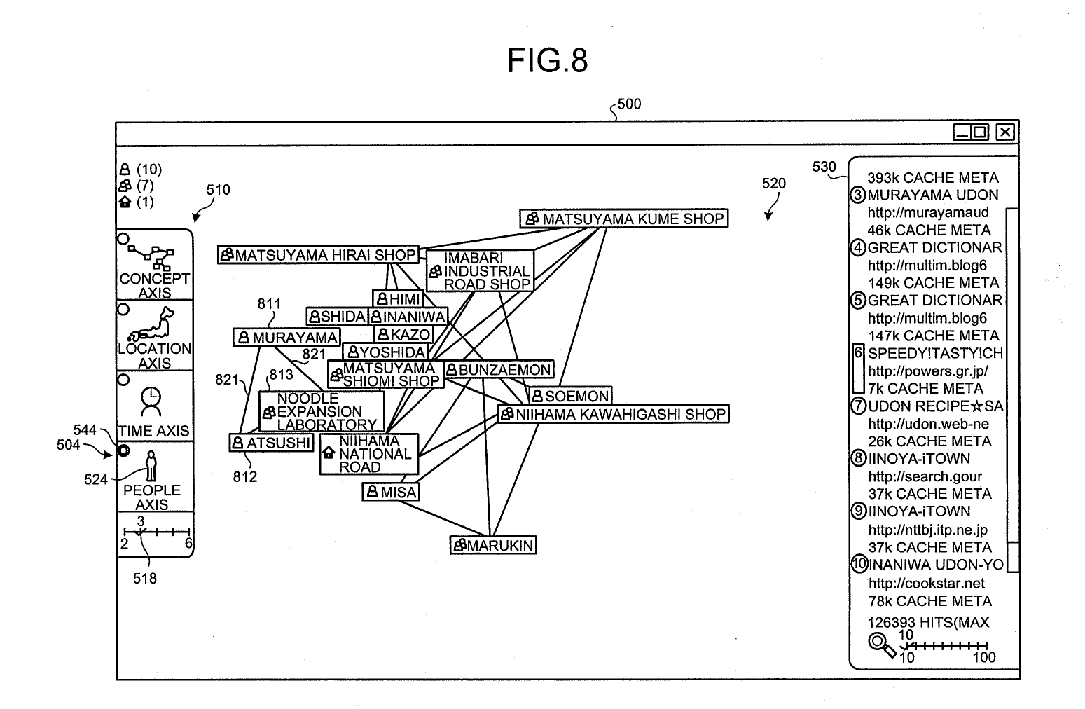

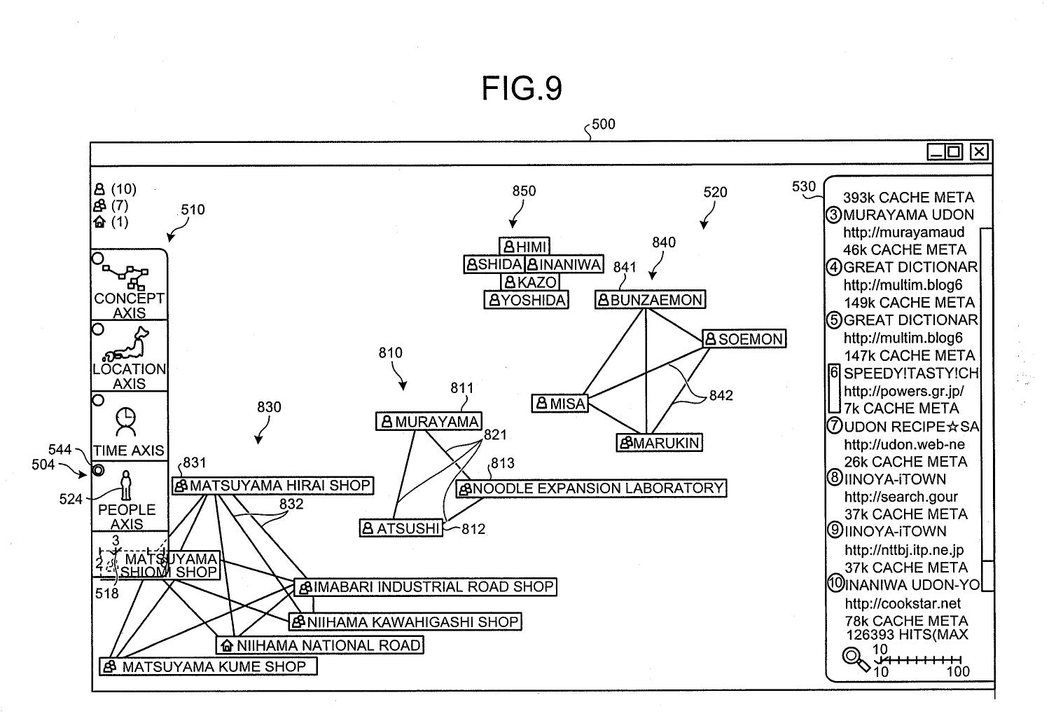

FIGS. 8 and 9 are diagrams of other examples of clustering. As depicted in FIG. 8, through a manipulation of a clustering selecting button 544 provided in the people search condition setting unit 504, personal connections included in text of the websites obtained as the above search results may be classified into three divisions based on the clustering.

In the state of FIG. 8, if the sixth website is selected from the list in the search result display window 530, the processing unit 352 causes the personal name information retrieving unit 344 to execute a search by a personal name(s) and organization name included in the sixth web page and display the search results on the main screen at the center. According to this website, for example, a “(Mr.) Murayama” 811 is related to “(Mr.) Atsushi” 812 and “Noodle Expansion Laboratory” 813, these relationships are indicated by a link (connection line) 821 connecting vertexes representing the three entities.

Thus, “(Mr.) Murayama” 811 has personal relationships with “(Mr.) Atsushi” 812 and the “Noodle Expansion Laboratory” 813. The personal name information retrieving unit 344 recognizes “(Mr.) Murayama” 811 and “(Mr.) Atsushi” 812 as individuals and “Noodle Expansion Laboratory” 813 as an organization and the display control unit 353 displays these names with their respectively corresponding icons attached thereto at the vertexes.

FIG. 9 depicts the state of FIG. 8 in which the vertexes are shifted by a manipulation of a mouse, etc. Even if the vertexes are shifted is such a manner, the display control unit 353 keeps the link 821 connecting the vertexes unchanged, only changing the lengths thereof. The link 821 exhibits a spring-like quality so that, if a vertex is shifted, other vertexes connected to the shifted vertex will be drawn in the same direction by the spring of the link 821.

As described, through a shift of a vertex via the mouse, etc., the classification that could not be discerned from FIG. 8 may be made clear. That is to say, the shifting of the vertex makes it possible to arrange at different positions a group 810 of personal connections including “(Mr.) Murayama” 811 closed by the links 821, a group 830 connected by links 832 and including “Matsuyama Hirai Shop” 831, a group 840 of personal connections including “Bunzaemon” 841 connected by links 842, and a group 850 of individuals without any connections. Such configuration enables personal connections to be grasped more clearly.

### (Screen Transition at Time of Axis Switching)

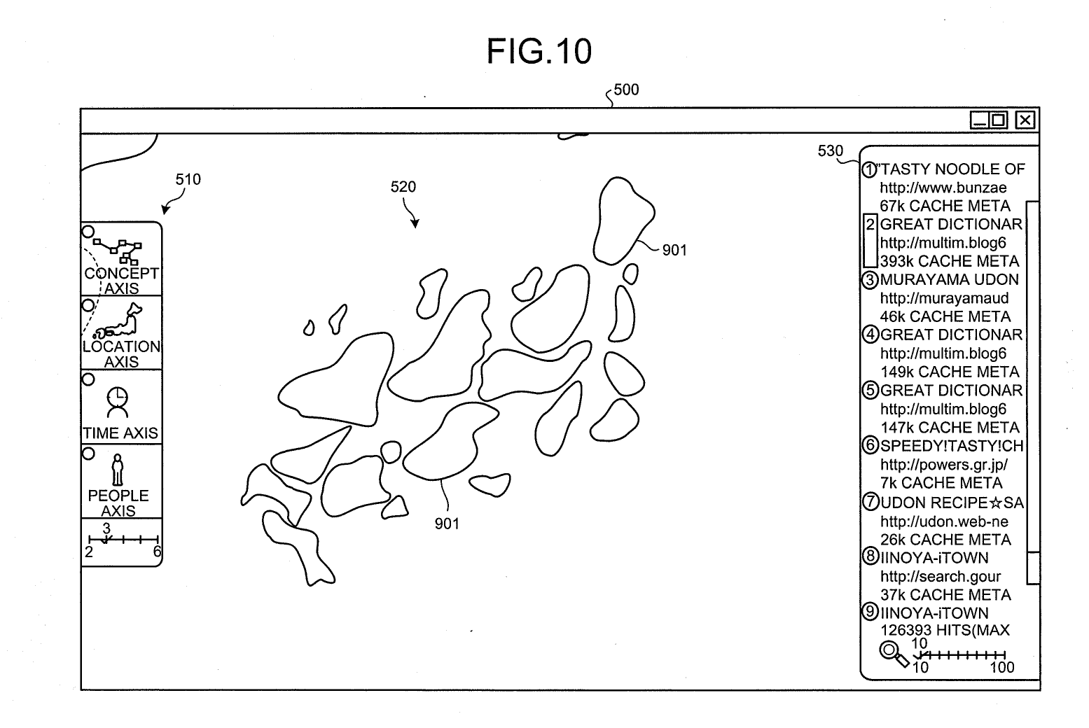

FIG. 10 is a diagram of an intermediate image when the axis of the search is switched. Before and after the switching of the axis, though this is not used for the retrieval display, the display control unit 353 performs image processing generally called morphing by gradually changing the display of the contents of the main screen 520 so that the display of the contents will continuously transform itself from the display screen before the axis switching to the display screen after the axis switching.

In this example, the display control unit 353 records the display screen depicted in FIG. 7 after the axis switching, together with screen data of the display screen of FIG. 6 before the axis switching. The display control unit 353 displays a virtual progress indicator 901 so that FIG. 6 may continuously switch to FIG. 7. Since FIG. 6 depicts the shape of a map and FIG. 7 depicts plural circles, the progress indicator 901 depicted in FIG. 10 generates and displays the shape in transformation from the map breaking up until the plural circles form. Not only the one screen depicted in FIG. 10 but screens depicting the gradually changing shape of the progress indicator 901 are displayed for a predetermined period of time. Conversely, in a case of switching from FIG. 7 to FIG. 6, the progress indicator 901 displays the circles being combined and transformed to the map.

While the screen switching by the computer may be completed in 0.0001 sec, 0.1 sec or more is needed for human visual recognition. Therefore, by giving 0.1 sec or more to smoothly switch the screen, recognition load is alleviated. As described, when search results are changed from one axis to another, the capability of switching, with continuity, a display screen to the subsequent display screen, does not bore the operator and may alleviate recognition load, unlike an instantaneous switching of the display screen.

### (Defocus Processing of Main Screen)

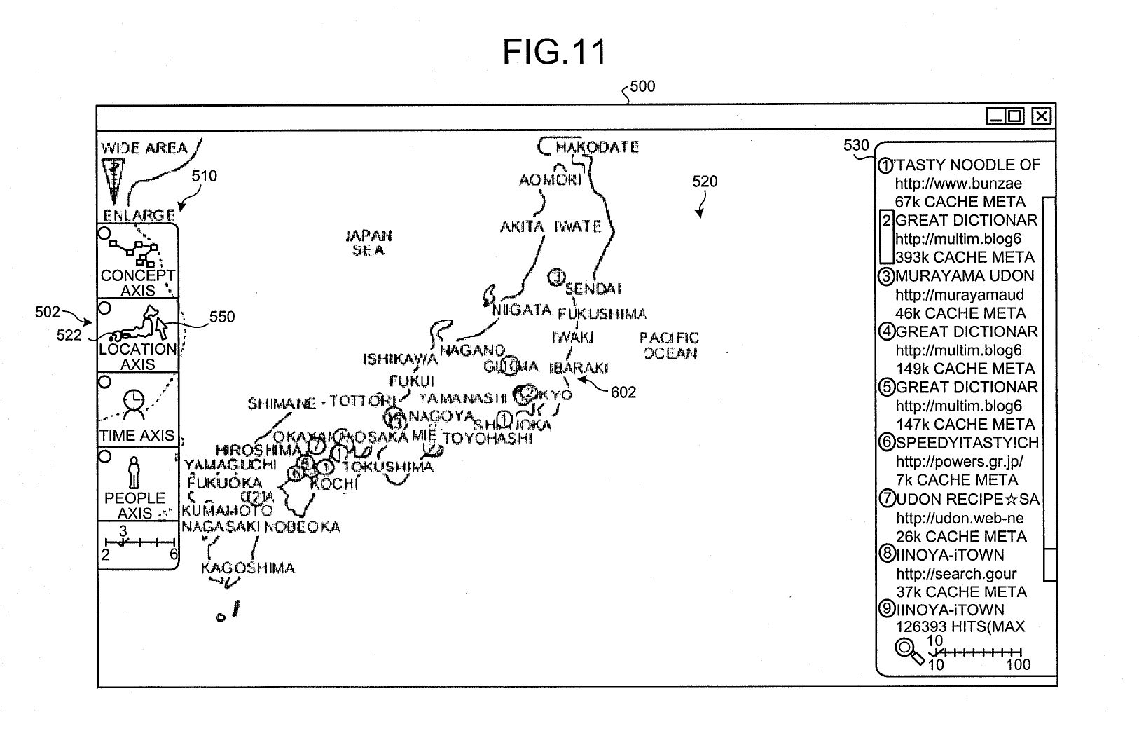

FIG. 11 is a diagram of the main screen in a defocused state. When, on the display screen 500, a cursor 550 is not located on the main screen 520, namely, the cursor 550 is on the axis window 510 as depicted or on the search result display window 530, the display control unit 353 performs the image processing to defocus the display of the main screen 520. After the map information 602 is displayed on the main screen 520 as depicted in FIG. 6, the cursor is moved to the axis window 510 and, at this moment, the display of the map information 602 is defocused as depicted in FIG. 11.

Such processing may prevent the user from paying attention to the display of the main screen 520 and make the user conscious of the operation with respect to the axis window 510 or the search result display window 530, thereby aiding user operation. As described, through the processing of defocusing the display in the area for displaying the search results (the processing being based on location of the cursor) in switching between viewing the information of the search results and not viewing the search results, the screen may be modulated to improve visual recognition. Further, cursor position may be determined.

### (Focus Timing of Search Result Display Window)

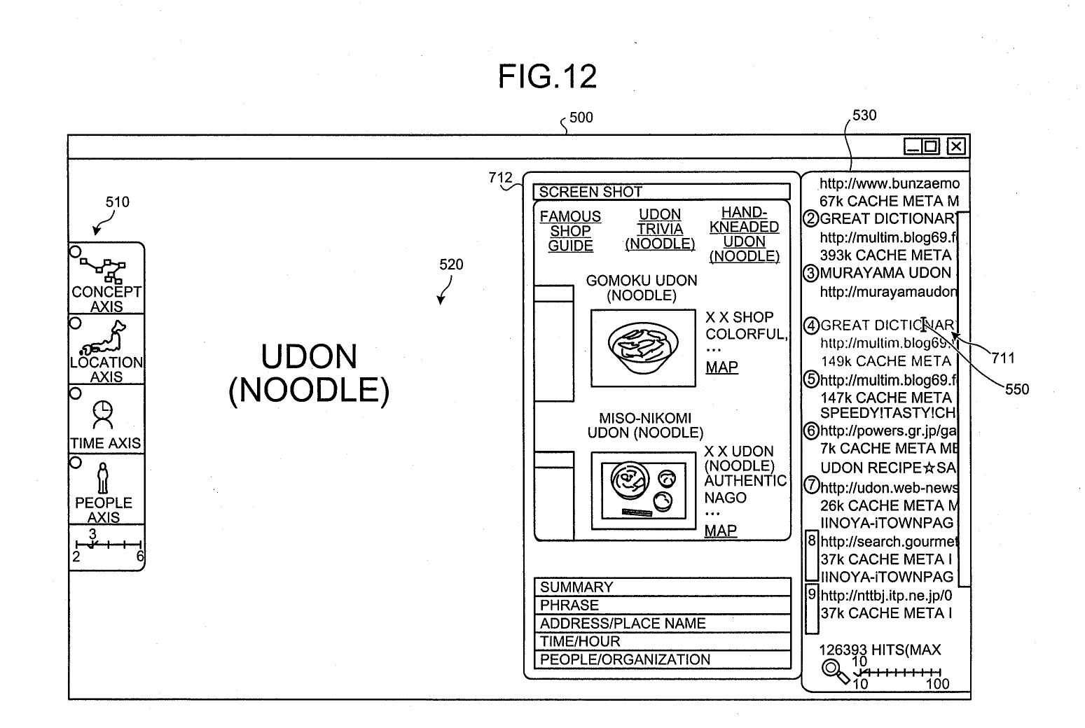

FIG. 12 is a diagram of focus switching of display characters in the search result display window. When, on the display screen 500, the cursor 550 is moved to the search result display window 530 and is located on a given search result, the display control unit 353 performs image processing so that title and address display 711 will be temporarily defocused and displayed in a color different from that of others, as depicted in FIG. 12 (the fourth item, “udon recipe . . . ”). The cursor 550, which is on the characters, is displayed as a vertical line “|”.

Thereafter, after the elapse of a predetermined time, for example, 1 sec, the display control unit 353 performs the image processing to put the title and address display in a focused (clearly visible) state. At this time, a detailed information display screen 712 of the seventh item “udon recipe . . . ” is displayed in such manner that the seventh item “udon recipe . . . ” is drawn from the search result display window 530 to the main screen 520. The detailed information display screen 712 is provided with tags including screen shot, summary, phrase, address/location name, time/hour, people/organization, etc. The screen shot is a graphical version of the corresponding website and represents the results of the search by the word retrieving unit 341, the address/location name information retrieving unit 342, the time information retrieving unit 343, and the personal name information retrieving unit 344. In the search result display window 530, through a selection operation (mouse click) at the location of, for example, the seventh item “udon recipe . . . ”, the corresponding website is displayed as a separate screen.

As described, by focusing and defocusing an item selected in the search result display window 530 (information of corresponding web page), the selected item may be made conspicuous and even if the cursor 550 is positioned on the text. There is no occurrence of losing sight of the location of the selected item and visual recognition may be improved. Even if the cursor is located on a character string of a search result item and is displayed as the vertical line “|” making it difficult to distinguish the cursor from the surrounding text, what is changed is not the display state of the cursor but the display state of the search result item on which the cursor is positioned and therefore, the selected item is easily distinguishable.

### (Addition and Clear of Narrowing-Down Condition)

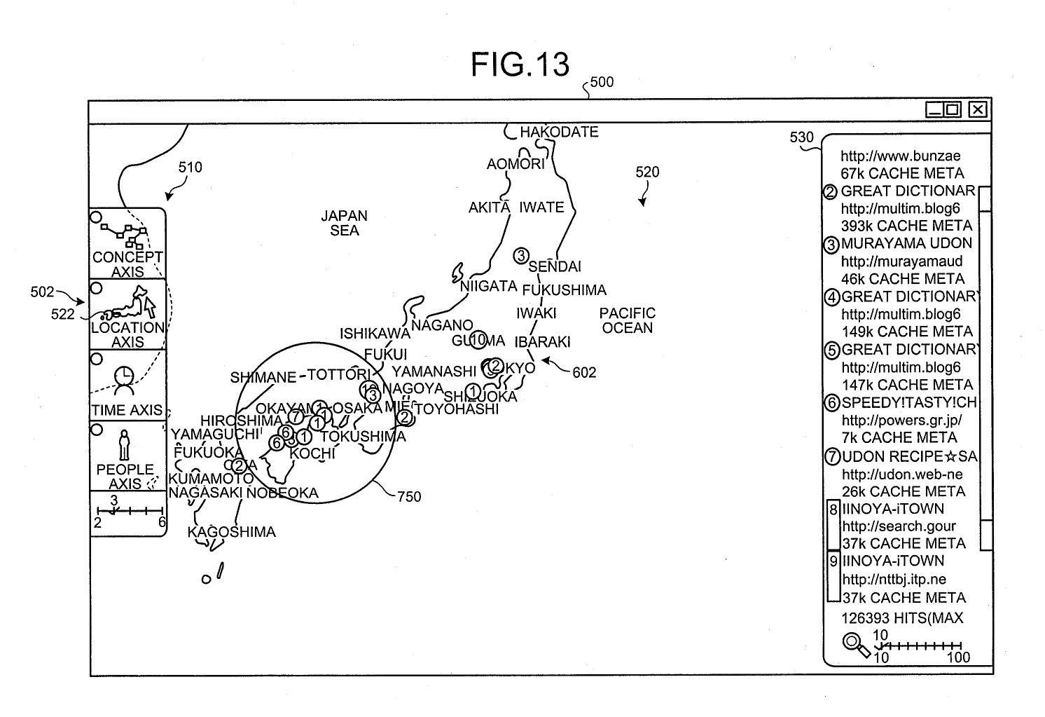

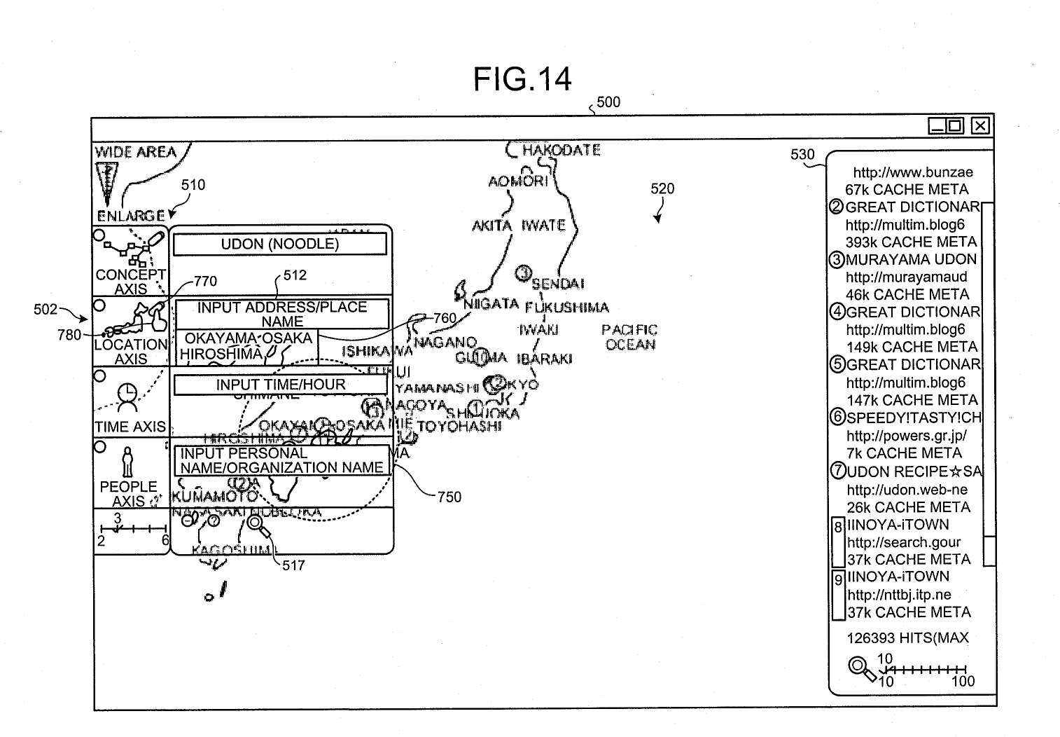

FIGS. 13 and 14 are diagrams of the state in which narrowing-down conditions are added. An example will be described of adding search conditions for a search by another axis when the retrieval results are displayed on the main screen 520. It is assumed that for example, as depicted in FIG. 6, a search is made for “udon” by the phrase retrieval axis and the map information 602 is displayed as the search results on the main screen 520. With this map information displayed on the main screen 520, if a desired area range is designated using the mouse, the processing unit 352, judging this range as a designated range on the map, sets the search phrase for the narrowing-down to the address/location name information retrieving unit 342. The example depicted in FIG. 13 is one of selecting an area, a selected area 750, in circular shape using the mouse.

Consequently, as depicted in FIG. 14, below the item input unit 512 of the location axis search condition setting unit 502 of the axis window 510, a snap shot 760 corresponding to the selected area 750 depicted in FIG. 13 is displayed and phrases (e.g., Hiroshima, Okayama, Osaka, etc.) representing the areas included in the selected area 750 are temporarily kept as the narrowing-down phrases. Thereafter, manipulation of the search button 517 makes it possible to perform a search with the search results of the “udon” narrowed down by the selected area 750. The narrowing-down conditions by the selected area 750 may be cleared by placing the cursor 780 at the location of a clearing icon (depicted clip mark) 770 and clicking it.

The example described using FIGS. 13 and 14 is a case of displaying the map information 602 on the main screen 520 and narrowing down the area and likewise, with respect to time and people search conditions as well, by designating a range on the display of the main screen 520 using the mouse, etc., time and people may easily be set as the narrowing-down conditions.

According to the above configuration, since, in performing the narrowing-down search, there is no need for inputting phrases in the item input units 511 to 514 provided in the search condition setting unit of respective axes and the narrowing-down phrases may be set by merely making selection such as designating a range with respect to the information displayed on the main screen 520, a narrowing-down search may be performed easily. Conversely, with respect to the clearing of the narrowing-down conditions as well, since the clearing may be performed by each axis, the trouble of clearing the search conditions for all axes and setting them again may be saved and the clearing of the narrowing-down conditions as well may be performed easily.

(Period Display with Time Axis)

According to the retrieval by the time information retrieving unit 343, the search may be performed with time information such as year, date, and time of web pages as a key. The processing unit 352 further consolidates and arranges the acquired time information according to a predetermined period and the display control unit 353 may display such retrieval results using a period axis.

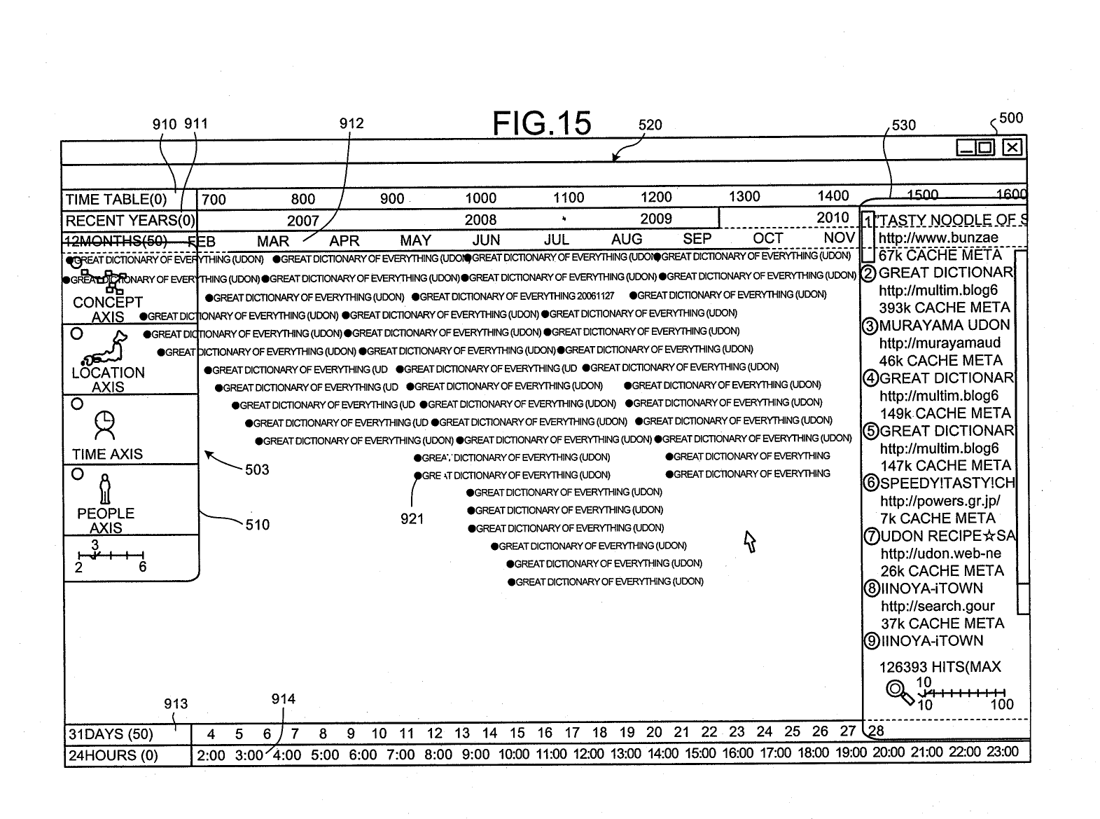

FIG. 15 is a diagram of an example of period display by a date of the search results by the time axis. As depicted, the search results by the time search condition setting unit 503 are displayed on the main screen 520 and the main screen 520 displays, along a horizontal band, a time scale 910 covering centuries and below the time scale 910, a time scale 911 covering several years straddling the current year. The main screen 520 further displays, as a predetermined period, a scale 912 covering one year (12-month period), a scale 913 covering one month (31-day period), and a scale 914 covering one day (24-hour period), likewise extending horizontally in a long, narrow strip.

Among the scales 910 to 914, the scale of the selected time axis is displayed at the uppermost position of the lower part of the screen. In the example depicted in FIG. 15, the scale 913 covering one month (31-day period) is in the selected state. In this state, the main screen 520 displays the websites carrying description of the corresponding dates according to the scale 913 covering one month (31-day period). For example, circle mark 921 among the search results indicates the website of the “Great Dictionary of Everything, Udon” carrying the description of the date of 11th day. Such display by day of the month, makes it possible to easily grasp the information of which day of the month is much included.

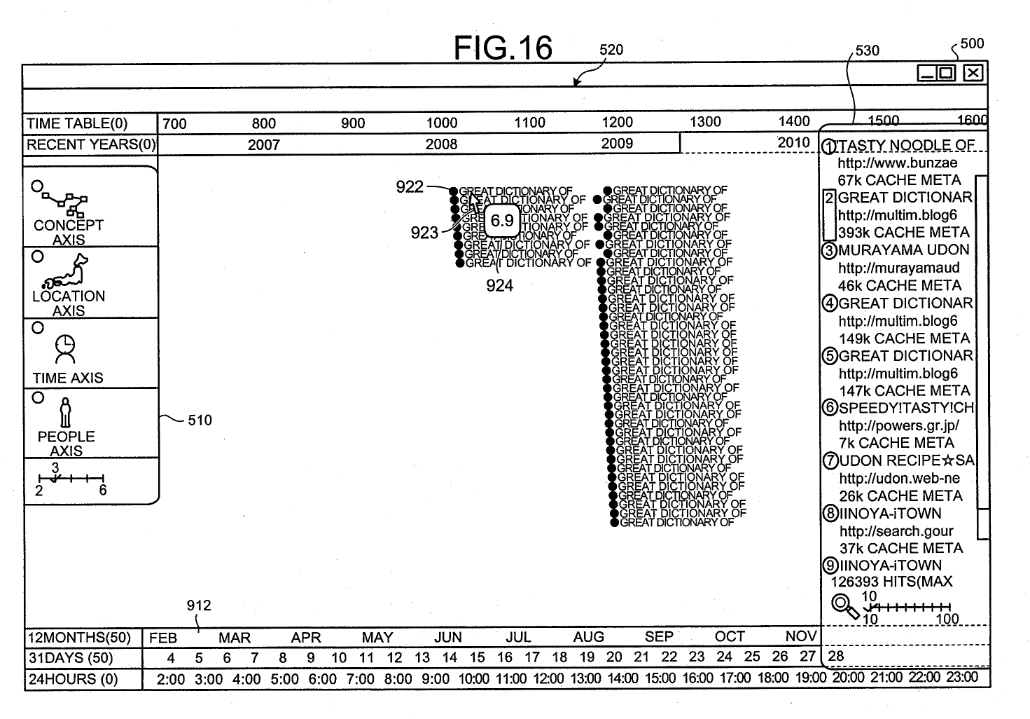

FIG. 16 is a diagram of an example of period display by a month of the retrieval results by the time axis. In this case, the selected scale 912 covering one year (12-month period) is located at the uppermost position of the lower part of the screen. The information as the search results is the same as in FIG. 15 but as compared with FIG. 15, the main screen 520 displays the websites carrying description of the corresponding months according to the scale 912 covering one year (12-month period). For example, circle mark 922 among the search results indicates the website of the “Great Dictionary of Everything, Udon” carrying the description of the month of June. Such display by month of one year, makes it possible to easily grasp the information of which month is much included and to easily grasp that there are many descriptions from June through August. By such displays as the examples depicted in FIGS. 15 and 16, for example, trends, etc. such as renewal month of a website may be grasped. More specifically, events such as “a sale on the 1st day of every month” and “a festival in August, every year” may be discovered.

As described previously, if the cursor 923 is located on a given the search result on the main screen 520, “6.9” is displayed by a pop-up indicator 924. Similarly, the indicator 924 may display what kind of phrase included in the website is construed as the date/time. In the example depicted, “6.9” is construed as “June 9th” and displayed.

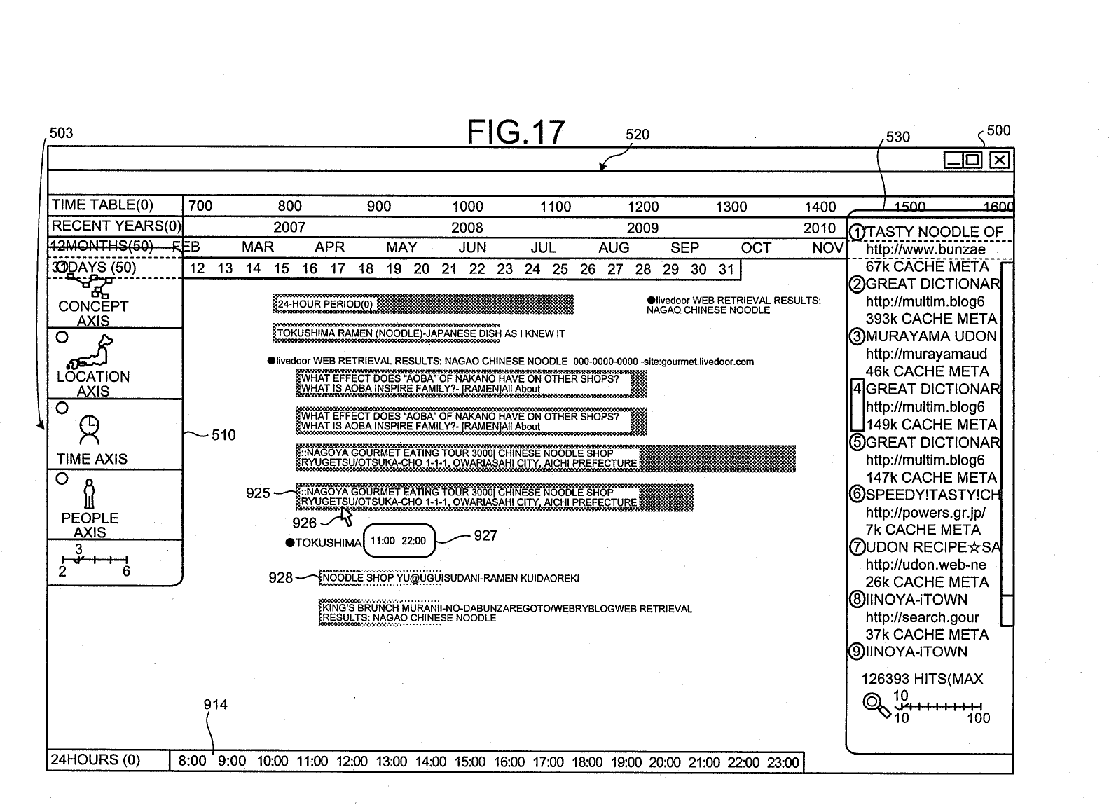

FIG. 17 is a diagram of an example of period display by an hour of the search results by the time axis. In this example, the selected scale 914 covering one day (24-hour period) is located at the uppermost position of the lower part of the screen. The main screen 520 displays the websites carrying description of the corresponding hours according to the scale 914 covering one day (24-hour period). For example, a bar 925 of the search results indicates the website carrying description of “Nagoya Gourmet Eating Tour, Chinese Noodle Shop Ryugetsu” carrying description of an opening time of 11:00 and a closing time of 22:00. Such display makes it possible to organize the information on websites by day. Especially, if there is description of a time period (opening time to closing time) as above, by displaying the time period in a long, narrow strip extending along the time-axis direction, the business hours of shops may easily be obtained. Such display makes it possible, for example, to grasp trends, etc. concerning the business hours of shops.

Although previously described, if the cursor 926 is located on the above search result on the main screen 520, “11:00 22:00” is displayed by a pop-up indicator 927 and a more detailed time frame (opening time is 11:00 and closing time is 22:00) of the information on which the cursor is located may be displayed.

If only the opening time is obtained from the search result, a long, narrow strip may be displayed thickly only at the opening time and progressively less thickly along the time-axis. For example, a bar 928 indicates a website carrying description of “Noodle Spot Yu@Uguisudani” with the opening time described as 11:30, where the closing time is unknown. Correspondingly, even if there is a description of only the opening time, the bar 928 may be displayed accordingly. Conversely, when there is a description of only a closing time, configuration is such that a long, narrow strip is displayed more and more thickly along the time-axis.

As described, according to the embodiments, an addition of operations to the display screen displaying search results enables the search results to be narrowed down easily, thereby eliminating the need for operations concerning plural search conditions involving the input of phrases and enabling the narrowing-down operation to be easily performed.

In particular, since the results of searches based on search conditions of different categories are displayed respectively in a suitable display mode, the search results may be grasped intuitively and easily. In the display mode in which the search results are displayed, the retrieval results by another category may also be displayed; thus, the search results based on various search conditions may easily be obtained without switching the display screen and organization of the information may be supported, without causing disorder to the information obtained as the search results.

The retrieving method explained in the present embodiment can be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program can be a transmission medium that can be distributed through a network such as the Internet.

The present invention enables the narrowing-down, etc. of search results using plural search conditions and intuitive, easy-to-understand display of the search results even for complex searches by search conditions of different categories.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A retrieving apparatus comprising:
an input unit that receives a plurality of search conditions of different categories;
a plurality of search units that are provided respectively for each of the categories and execute searches based on the search conditions;
a processing unit that, based on the search conditions received by the input unit, causes a search unit provided for a corresponding category to execute a search and outputs search results obtained; and
a display control unit that causes the search results output from the processing unit to be displayed by a display screen having a layout corresponding to the category, wherein
the processing unit, through an operation of the display screen depicting the search results, further receives search conditions of another category to narrow down the search conditions.

2. The retrieving apparatus according to claim 1, wherein
the processing unit, using search conditions of a given category received by the input unit, causes other search units to execute a search.

3. The retrieving apparatus according to claim 2, wherein
the display control unit, when a first category of the search results is switched to a second category, displays the search results using the display screen having a layout corresponding to the second category.

4. The retrieving apparatus according to claim 1, wherein
the processing unit when, on the display screen of a layout displaying the search results based on a first category, selection operation for narrowing-down by second category is received by the input unit, temporarily keeps the search conditions corresponding to the selection operation on the display screen as the search condition of the second category.

5. The retrieving apparatus according to claim 4, wherein
the processing unit causes the search results based on the second category to be displayed on the display screen of the layout displaying the search results based on the first category.

6. The retrieving apparatus according to claim 1, further comprising:
an acquiring unit that acquires contents by way of a network; and
an analyzing unit that, by named entity extraction, extracts information by category related to phrase, location, time, and people included in the contents and registers the information in a database, wherein
the search units, based on search conditions related to phrase, location, time, and people, refer to the database and retrieve the contents matching the search conditions.

7. The retrieving apparatus according to claim 6,
wherein the display control unit displays on the display screen of a map layout, the search results related to the location.

8. The retrieving apparatus according to claim 6,
wherein the display control unit displays on the display screen of a layout having a time axis, the search results related to the time.

9. The retrieving apparatus according to claim 8, wherein
the display control unit, when a search unit that executes a time-related search obtains time information of a start time, an end time, and a combination thereof as the search results, displays the time information of the start time, the end time, and the combination thereof in a long, narrow strip along the time axis.

10. The retrieving apparatus according to claim 6, wherein
the display control unit displays people-related search results on the display screen having a layout where a person, as a vertex, is connected to another person by a link.

11. The retrieving apparatus according to claim 1, wherein
the search unit classifies the search results by clustering, and
the display control unit displays on the display screen, results of the clustering by a given layout.

12. The retrieving apparatus according to claim 3, wherein
the display control unit, when the first category of the search results is switched to the second category, executes image processing of continuously and gradually changing the display screen of the layout before and after the switching.

13. The retrieving apparatus according to claim 1, wherein
the display control unit, when a cursor operated through the input unit is not located on an area displaying the search results, executes image processing of defocusing the area displaying the search results.

14. The retrieving apparatus according to claim 1, wherein
the display control unit, when a cursor operated by the input unit is located in an area displaying a list of the search results, executes image processing of temporarily defocusing display of a corresponding search result item and then focusing the corresponding search result item.

15. A retrieving method comprising:
receiving a plurality of search conditions of different categories;
searching with respect to each of the categories and based on the search conditions;
processing to, based on the search conditions received at the receiving, cause searching with respect to a corresponding category and output search results obtained; and
controlling to cause the search results output at the processing to be displayed by a display screen having a layout corresponding to the category, wherein
the processing includes processing, through an operation of the display screen depicting the search results, to further receive search conditions of another category and narrow down the search conditions.

16. A computer-readable recording medium storing therein a retrieval program that causes a computer to execute the retrieving method according to claim 15.
